(19) United States
(12) Patent Application Publication
(10) Pub. No.: US 2026/0118829 A1
(43) Pub. Date: Apr. 30, 2026

(54) OSCILLATING GLASSWARE CLOCK WITH STROBED ILLUMINATION

(71) Applicants: Scott Nietfeld, Seattle, WA (US); Paul Nietfeld, Corvallis, OR (US)

(72) Inventors: Scott Nietfeld, Seattle, WA (US); Paul Nietfeld, Corvallis, OR (US)

(21) Appl. No.: 19/366,961

(22) Filed: Oct. 23, 2025

Related U.S. Application Data
(60) Provisional application No. 63/713,728, filed on Oct. 30, 2024.

(51) Int. Cl. G04B 47/04; G04B 45/00

(52) U.S. Cl. CPC G04B 47/04; G04B 45/0007

(57) ABSTRACT

A clock assembly includes a base to receive a bottom of a glassware, posts extending from the base, a clock disposed on the one or more posts, a frame to be at least partially disposed within an annulus of the glassware, and lighting elements to output light to illuminate the glassware. The frame has a first drive and sensing inductor that generates a first magnetic field to displace one or more first magnetic elements disposed on the glassware, and senses a first movement associated with the one or more first magnetic elements. A second drive and sensing inductor generates a second magnetic field to displace one or more second magnetic elements disposed on the glassware, and senses a second movement associated with the one or more second magnetic elements.

### CROSS-REFERENCE TO RELATED APPLICATIONS

This application claims priority to U.S. Provisional Patent Application No. 63/713,728, filed Oct. 30, 2024, entitled “Oscillating Glassware Clock with Strobed Illumination,” the entirety of which is herein incorporated by reference.

### BACKGROUND

Traditional clocks typically rely on quartz crystal oscillators or mechanical pendulums for timekeeping. While these methods are reliable and accurate, they lack visual appeal and novelty. There is a growing interest in unique and visually striking timepieces that serve both functional and decorative purposes.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates an example clock assembly holding an example glassware, according to an example of the present disclosure.

FIG. 2A illustrates a first side view of the clock assembly of FIG. 1, according to an example of the present disclosure.

FIG. 2B illustrates a second side view of the clock assembly of FIG. 1, according to an example of the present disclosure.

FIG. 3A illustrates an example attachment mechanism of the clock assembly of FIG. 1, showing the attachment mechanism in a first state to secure the glassware to the clock assembly, according to an example of the present disclosure.

FIG. 3B illustrates the attachment mechanism of FIG. 3A, showing the attachment mechanism is a second state to receive or release the glassware from the clock assembly, according to an example of the present disclosure.

FIG. 4 illustrates the clock assembly of FIG. 1, showing the glassware removed, according to an example of the present disclosure.

FIG. 5A illustrates a first view of example components of the clock assembly of FIG. 1 to impart vibration to and illuminate the glassware, according to an example of the present disclosure.

FIG. 5B illustrates a second view of the components of FIG. 5B, according to an example of the present disclosure.

FIG. 6A illustrates example components of the clock assembly of FIG. 1 to impart vibration to the glassware, showing the components disposed within an annulus of the glassware, according to an example of the present disclosure.

FIG. 6B illustrates a cross-sectional view of the components of FIG. 6A disposed within the annulus of the glassware, taken along line A-A of FIG. 6A, according to an example of the present disclosure.

FIG. 7 illustrates a partial view of the glassware of FIG. 1, showing example magnetic elements coupled to the glassware, according to an example of the present disclosure.

FIGS. 8A-8C illustrate various views of an example clock assembly holding an example glassware, according to an example of the present disclosure.

FIGS. 9A-9D illustrate different arrangements of components to impart vibration to the glassware, and their associated vibration, according to an example of the present disclosure.

FIG. 10 illustrates an example functional block diagram of the clock assembly of FIG. 1 or the clock assembly of FIGS. 8A-8C, according to an example of the present disclosure.

FIG. 11 illustrates an example functional block diagram of the clock assembly of FIG. 1 or the clock assembly of FIGS. 8A-8C, according to an example of the present disclosure.

### DETAILED DESCRIPTION

This application is directed, at least in part, to a clock assembly that uses glassware as a resonator, according to an example of the present disclosure. In some instances, the clock assembly includes a base that secures the glassware and inductors that induce vibration to the glassware. The inductors may generate magnetic fields via outputting signals. Magnetic elements couple to the glassware and interact with the magnetic fields. For example, as the inductors generate the magnetic fields, the magnetic elements are displaced, and given their coupling to the glassware, corresponding portions of the glassware are displaced. Lighting elements may output light into, around, and/or adjacent to the glassware to permit observation of the displacement of the glassware. The magnetic fields and the lighting elements may be tuned based on characteristics of the glassware.

The glassware may be any suitable glassware, such as a wine glass, pint glass, or margarita glass. The glassware may be manufactured from any suitable glass material. In some instances, the glassware includes a stem that is securable to a base of the clock assembly. For example, the base may include an attachment mechanism that functions to secure the glassware to the base. In some instances, the attachment mechanism may include a twist-n-lock mechanism, a slide-n-lock mechanism, etc. Alternatively, the attachment mechanism may include one or more straps, bands, magnetic elements, etc., that are used to couple the glassware to the base. In some instances, the attachment mechanism may accommodate different bottoms of glassware for accommodating different types of glassware (e.g., wine glass, martini glass, etc.). Moreover, in some instances, the attachment mechanism may be capable of being resized, expanded, contracted, etc., to accommodate different types of glassware. Still, in some instances, different attachment mechanisms may be used in conjunction with the base to permit different types of glassware to be used with the clock assembly. As such, the clock assembly may include interchangeable attachment mechanisms, or bases, that make the clock assembly usable across a range of glassware types.

The base may support the clock assembly on a shelf, counter, surface, etc. In some instances, one or more posts (e.g., columns, pillars, etc.) extend from the base and support a clock. The clock may be representative of any suitable clock with an hour, minute, and/or second hands. The one or more posts may support or dispose the clock vertically above the glassware such that the glassware may be disposed between the base and the clock. In some instances, the clock may be disposable at various locations along the one or more posts. For example, the clock may be positionable at different locations along the posts to dispose the clock at various heights relative to the glassware.

The drive inductors may be disposed on a frame. In some instances, the frame is disposable within an annulus (e.g., rim, open end, etc.) of the glassware. In other instances, the frame is disposable external to the glassware, around the glassware, etc. In some instances, the frame extends from the clock (e.g., a housing of the clock) and into the annulus of the glassware. For example, struts may extend from the clock to dispose at least a portion of the frame internal to the glassware. The frame may be disposable along various lengths of the struts to dispose the frame internal to the glassware. This permits the clock assembly to accommodate various types, or heights, of glassware. In some instances, the struts represent telescopically extending members.

The inductors may be disposed on a printed circuit board (PCB), printed circuit board assembly (PCBA), etc., of the frame. In some instances, the inductors are disposed at least partially internal to the annulus of the glassware. As introduced above, the inductors are configured to generate magnetic fields for imparting motion to the glassware. The inductors output signals (e.g., electrical signals) for generating the magnetic fields. The frame may include any number of the inductors, and in some instances, the inductors may be arranged in pairs that are diametrically opposed from one another on the frame, PCB, etc. The positioning permits the glassware to be correspondingly pushed and pulled at diametric locations. For example, the inductors generate magnetic fields that correspondingly act on the magnetic elements to either push or pull corresponding portions of the glassware. The portions of the glassware that are pushed and pulled may be opposed form one another, and the inductors may operate in unison to either output signals, or refrain from outputting signals, in order to impart motion to the glassware in a push and pull fashion. As such, the inductors may generate corresponding magnetic fields that permit the magnetic elements to be pushed (e.g., opposition) or pulled (e.g., attraction) relative to the inductors.

The magnetic elements may be coupled to the glassware using any suitable means. In some instances, the magnetic elements are adhered, affixed, integrated, etc., to the glassware. In other instances, the magnetic elements may include a first magnetic element and a second magnetic element, where the first magnetic element and the second magnetic element may magnetically attract to one another to secure the first magnetic element and the second magnetic element to the glassware (e.g., the glassware may be interposed between the first magnetic element and the second magnetic element). In some instances, the magnetic elements are disposed adjacent to the inductors such that the magnetic elements are capable of being displaced to move (e.g., vibrate, oscillate, etc.) the glassware. In other words, disposing the magnetic elements adjacent to the inductors permits the magnetic elements, and correspondingly, the portions of the glassware, to be displaced. The glassware may be rotatable within, or on, the base (e.g., prior to being secured via the attachment mechanism) to position the magnetic elements adjacent to the inductors.

Any number, or pairs, of the magnetic elements may be disposed on the glass (e.g., two, four, six, ten, etc.). In some instances, the magnetic elements may be disposed at antinodes of the glassware. Moreover, in some instances the glassware may include an odd number or pairs of the magnetic elements. In some instances, the glassware includes a corresponding number of magnetic elements as the inductors. The magnetic elements may be permanent magnets, a ferrous material, electromagnets, etc. The magnetic elements may alternatively be referred to herein as “magnets.”

In addition to generating the magnetic field, the inductors may be used to sense the vibration of the glassware. In some instances, the inductors may sense the vibration of the glassware via sensing a magnetic field generated by the magnetic elements. In some instances, the inductors may be considered sense and drive inductors, in that the inductors are responsible for both driving the magnetic elements and sensing a corresponding movement of the magnetic elements via their differing magnetic fields. For example, as the magnetic elements move with the glassware, the sense inductors may sense the changing magnetic field (e.g., a strength of the magnetic field generated by the magnetic elements) to sense the vibration of the glassware or correlate the changing magnetic field with a movement of the glassware.

However, in other instances, the inductors may include drive inductors and sense inductors. Regardless of the specific implementation, drive inductors may be used to impart or sustain vibration of the glassware, the sense inductors may be used to sense vibration of the glassware. Examples of the drive inductors include inductive drivers, capacitive drivers, and/or acoustic drivers. Examples of the sense inductors include inductive sensors, capacitive sensors, optical sensors, and/or acoustic sensors. More generally, however, the clock assembly may include an electronic circuit that processes signals from a sensing mechanism and provides drive signals to a driving mechanism to maintain vibration of the glassware. The sensing mechanism may include any suitable sensor, for example, that sense a displacement of the glassware, a magnetic field associated with the magnetic elements for deducing the displacement of the glassware, and so forth. Moreover, motion of the glassware may be sensed optically using an LED/photodiode pair, or acoustically using a microphone. The driving mechanism includes any suitable driver, such as inductors, audio output devices, etc., for imparting motion to the glassware. For example, speaker may be used in place of an inductor to drive the glassware acoustically.

In some instances, not all of the inductors may be usable. For example, depending upon the desired vibration of the glassware, certain inductors may be activated while other inductors may be deactivated. As such, only a subset of the inductors may be used to impart motion to the glassware.

In some instances, the clock may be analog or digital. The clock may, in some instances, include a visual display. In some instances, the clock operates from a standing wave on the glassware with a high Q resonant mode. For example, a clock signal may be generated from the voltage induced in the sense inductor(s) by means of digital logic (e.g., a Schmidt trigger) and the clock signal may be used to drive a stepping motor of the clock. The glassware may be tuned to a specific frequency (e.g., an integer or power-of-two number of cycles per second) that enables the motor drive signal to be generated directly from an output of a counter. Alternatively, digital logic methods such as fractional-N synthesis may be employed to generate the motor drive signal from the glassware's natural resonant frequency. The frequency of the glassware may be used as a resonator to drive the clock and/or determine time keeping. A clock signal generation circuit may convert the processed signals into a time signal, which may then be used to move the hands of the clock.

The clock assembly also includes the lighting elements (e.g., lights, light source, illumination source, etc.) for illuminating at least a portion of the glassware. In some instances, the lighting elements are disposed on the frame. Alternatively, in some instances, the lighting elements are disposed on the struts that extend from the clock, such that the lighting elements are disposed between the clock and the frame. In some instances, the lighting elements are disposable at different locations on the struts such that the lighting elements are disposable at different distances from the glassware. The lighting elements may be disposed on a PCB, which may include a ring shape for illuminating around, internal to, external to, etc., the annulus of the glassware. In some instances, the PCB and the lighting elements may be referred to as a light assembly. Any number of lighting elements may be used and the lighting elements may be controlled to output different colors of light, different intensities of light, etc. Suitable lighting elements include light emitting diodes (LEDs), organic LEDs (OLEDs), etc.

In some instances, the lighting elements may be controlled to output light based on the vibration of the glassware. For example, the lighting elements may be controlled based on the magnetic field (or signals) generated by the inductors. Alternatively, the lighting elements may be controlled based on the magnetic field generated by the magnetic elements coupled to the glassware and as sensed by the inductors. The lighting elements may also be controlled based on the motor drive signal and/or the time signal. This permits the light output by the lighting elements to accommodate the vibrations of the glassware. In some instances, the lighting elements may turn on and off to provide a strobing effect.

In some instances, the inductors may be referred to, or represent, a resonator circuit, where the resonator circuit includes the inductors for imparting and sensing movement of the glassware. In some instances, the inductors and/or the frame may be referred to as an inductor assembly. Moreover, although described as separate components, in some instances, the resonator circuit (or the inductor assembly) and the lighting assembly may be integrated within a single assembly, circuit, etc.

In some instances, the clock assembly includes controls (e.g., knobs, dials, levers, switches, buttons, etc.). The controls may be used to adjust the vibrations imparted to the glassware, for example, by changing the magnetic field (or signals) generated by the inductors. In some instances, the controls may adjust a frequency, amplitude (e.g., volume), etc., of the signals output by the drive inductors. The adjustment to the signals may tune the signals to the specifics of the glassware (e.g., size, material, etc.) to permit vibration of the glassware. The controls may also adjust a strobe frequency or phase of the lighting elements, a color of the lighting elements, a brightness of the lighting elements, etc. In some instances, the controls are located on the base, the clock, the frame, the struts, etc. Although described as manual controls, in some instances, functions of the clock assembly may be controlled via inputs to a touch screen. Moreover, the clock assembly may communicatively couple to one or more devices (e.g., a mobile phone) via one or more network interfaces (e.g., Bluetooth, Wi-Fi, etc.). A user may interact with the one or more devices to control functions of the clock assembly.

In some instances, the lighting elements may include a laser oriented to a laser beam into the glassware. The laser may be arranged adjacent to a side of the glassware and pointed or oriented into the glassware. The laser beam may be arranged to demonstrate a total internal reflection within the glassware and to visually highlight the motion of the glassware rim. Additionally or alternatively, the beam may be passed through a spreader lens to more evenly illuminate the glassware.

The clock assembly may include additional or alternative components other than those listed and described herein. For example, the clock assembly may include flexible printed circuits (FPCs) that connect components (e.g., inductors, lighting elements, clock, etc.) to one another. Moreover, the clock assembly may include processor(s) that carry out functions of the clock assembly and memory that stores instructions executable by the processor(s). In some instances, the clock assembly may be mains powered or battery powered. The clock assembly may also include field-programmable gate arrays (FPGAs) for controlling operations of the clock assembly.

In some instances, a polarizer may be used to visualize changing internal stresses within the glassware. The polarizers may be disposed between the lighting elements and the glassware and/or between the glassware and a viewpoint of an observer. For example, a first polarizer may be placed between the lighting elements and the glassware, and/or a second polarizer may be placed between the glassware and a viewer. The first polarizer and the second polarizer may form a polariscope to allow the changing internal stresses within the glassware to be visualized.

Although referred to herein as a “clock assembly,” the patent application may relate to any system, assembly, device, apparatus, etc. Moreover, the techniques described herein may be usable within other environments or applications. For example, the techniques may be used to induce vibrations, movement, etc., into other objects manufactured from glass, metal, plastic, composites, etc.

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment or instance may be combined with the features of other embodiments or instances. Such modifications and variations are intended to be included within the scope of the disclosure and appended claims.

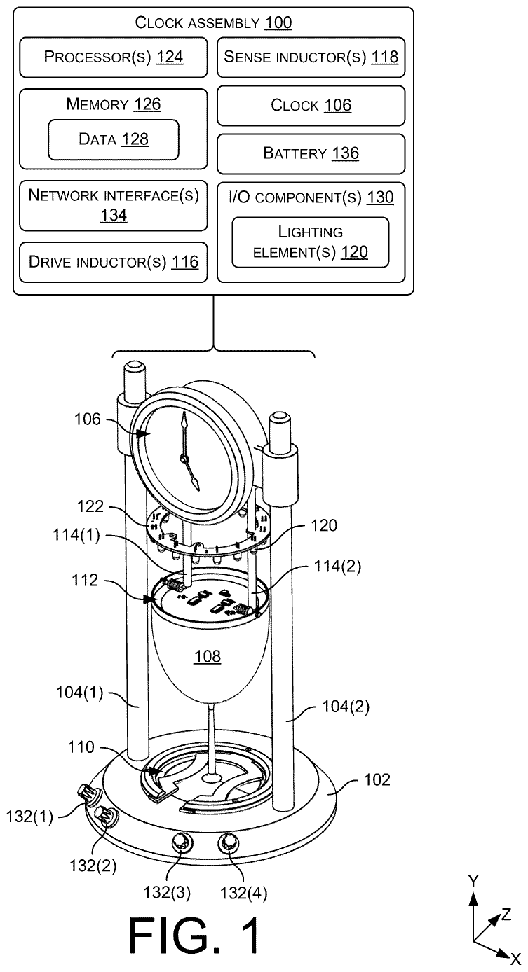

FIG. 1 illustrates an isometric view of an example clock assembly 100, according to an example of the present disclosure. The clock assembly 100 may include a base 102, one or more posts 104 (e.g., a post 104(1) and a post 104(2)) that extend from the base 102, and a clock 106. The base 102 may be disposed on any suitable surface, such as a counter, desk, shelf, etc. The clock 106 (or a housing of the clock 106) may be disposed along the posts 104, spaced apart from the base 102. In some instances, the clock 106 is disposable at different locations along the posts 104, for example, to raise and lower the clock 106 at different heights relative to the base 102. The clock 106 may include suitable hands (e.g., minute, hour, second). Although shown as including an analog clock, the clock 106 may be a digital clock, include a visual display, screen, etc.

The clock assembly 100 is configured to hold a glassware 108. The glassware 108 may be disposed on the base 102 and may be secured to the base 102 via an attachment mechanism 110. The attachment mechanism 110 may be representative of a twist-n-lock mechanism, a slid-n-lock mechanism, one or more straps, bands, etc. In some instances, the attachment mechanism 110 secures or engages with the bottom of the glassware 108.

The glassware 108 may be representative of any type of glassware, such as a wine glass, a pint glass, a martini glass, etc. In some instances, the attachment mechanism 110 accommodates the different types of glassware. Moreover, in some instances, different attachment mechanisms may be used depending upon the type of glassware. For example, the attachment mechanisms may be interchangeable depending upon the type of glassware.

The clock assembly 100 includes a frame 112 that is disposable at least partially within an annulus of the glassware 108. The frame 112 may extend from the clock 106, for example, via one or more struts 114 (e.g., a strut 114(1) and a strut 114(2)). In some instances, the frame 112 may hang within the annulus of the glassware 108. As will be described herein, the frame 112 may include drive inductor(s) 116 and/or sense inductor(s) 118 may be disposed on the frame 112. The drive inductor(s) 116 are configured to generate signals, or magnetic fields, for imparting motion to the glassware 108. For example, as will be explained herein, magnetic element(s) may be disposed on or coupled to the glassware 108, and the magnetic field generated by the drive inductor(s) 116 may displace the magnetic elements. Given the coupling between the magnetic elements and the glassware 108, the glassware 108 is correspondingly displaced during the displacement of the magnetic elements.

In some instances, the drive inductor(s) 116 work in tandem to pull or push corresponding portions of the glassware 108. In some instances, the drive inductor(s) 116 are diametrically opposed to one another on the frame 112. The frame 112 may include any number of the drive inductor(s) 116. In some instances, only a subset of the drive inductor(s) 116 may be activated, for example, depending upon the desired movement of the glassware 108. The drive inductor(s) 116 may be mounted to a PCB coupled to the frame 112.

The clock assembly 100 also includes the sense inductor(s) 118 that are responsible for sensing the movement of the glassware 108. In some instances, the sense inductor(s) 118 generate a signal associated with a magnetic field of the magnetic elements coupled to the glassware 108. As the magnetic elements move with the glassware 108, the sense inductor(s) 118 may generate signals corresponding to the changing magnetic field. This, in turn, may be associated with a movement of the glassware 108.

Although described and/or shown as separate components, in some instances, the drive inductor(s) 116 and the sense inductor(s) 118 may be integrated within a single inductor. That is, an inductor may be responsible for generating the magnetic field to displace the magnetic elements and generating a signal (or data) associated with the magnetic field of the magnetic elements. In some instances, the drive inductor(s) 116 may be controlled based on the sense inductor(s) 118, for example, to push and pull diametrically opposed positions on the glassware 108. The magnetic elements may be disposed at antinodes of the glassware 108, and the drive inductor(s) 116 and the sense inductor(s) 118 may be located adjacent to the antinodes.

In some instances, the clock 106 operates by developing a standing wave on the glassware 108 with a high Q resonant mode. For example, a clock signal may be generated from a sense signal by means of digital logic and is used to drive a Lavet-type stepping motor to move the hands of the clock 106. If the glassware 108 is tuned to a frequency that is a power of 2, the motor drive signal may be generated directly from an output of the counter. For example, if the glassware 108 is tuned to 256 Hz, then the 9th bit of the counter 434 will change state every second and may be used to generate a motor drive output. For glassware with natural frequencies that are not powers of 2, the glassware may be tuned to the nearest integer frequency and an additional binary comparator may be used to identify when the correct number of cycles has elapsed. Alternatively or additionally, digital logic methods (e.g., fractional-N frequency synthesis) may be employed to generate the motor drive signal from the glassware's natural resonant frequency. A clock signal generation circuit may convert the processed signals into a time signal, which may then be used to move the hands of the clock 106.

The clock assembly 100 may include lighting element(s) 120 to illuminate portions of the glassware 108. The lighting element(s) 120, as shown, may be disposed vertically above (e.g., in the Y-direction) the frame 112 and/or the glassware 108. The lighting element(s) 120 may be disposed on a substrate 122 (e.g., PCB) that couples to the struts 114. In some instances, the substrate 122 is disposable at different locations along the struts 114 to raise and lower the lighting element(s) 120 in relation to the glassware 108. This may accommodate different sizes of the glassware 108.

Although shown as separate components, in some instances, the lighting element(s) 120 may be disposed on the frame 112. In such instances, the drive inductor(s) 116, the sense inductor(s) 118, and the lighting element(s) 120 may be integrated within a single assembly, component, etc.

The clock assembly 100 is shown including processor(s) 124 and memory 126, where the processor(s) 124 perform various functions and operations associated with controlling operations of the clock assembly 100, and the memory 126 stores instructions executable by the processor(s) 124 to perform the operations described herein. For example, the processor(s) 124 may control the drive inductor(s) 116 to generate signals associated with the magnetic fields to displace the magnetic elements. The processor(s) 124 may also receive signals from the sense inductor(s) 118 associated with a movement of the magnetic elements coupled to the glassware 108 (e.g., via a changing magnetic field associated with the magnetic elements). In some instances, the processor(s) 124 may control the drive inductor(s) 116 in order to push and pull on corresponding portions of the glassware 108 that are diametrically opposed to one another.

The processor(s) 124 may receive, generate, store, etc., data 128 that is associated with controlling component(s) of the clock assembly 100. For example, the data 128 may be associated with a timing, frequency, amplitude, etc., of the signals generated by the drive inductor(s) 116. The data 128 may also be associated with signals generated by the sense inductor(s) 118, where the data is indicative of the magnetic field or the vibrations. The data 128 may also be used to control the output of the lighting element(s) 120. For example, the lighting element(s) 120 may output light based on the vibrations of the glassware 108. That is, knowing the vibrations of the glassware 108, the lighting element(s) 120 may be controlled to strobe, for example, to illuminate the vibrations.

The data 128 may also include temperature calibration coefficients, which would feed into the digital logic for producing the timing signal and motor output signals. For example, the vibration frequency of the glassware 108 might change from 268.3 Hz to 268.9 Hz as the temperature of the glassware 108 changes from 65-75 F. In some instances, the vibration frequency may be determined using a reference high-precision clock, store the coefficients as onboard calibration data, and use them as inputs to the fractional-N synthesis logic to compensate for temperature drift.

The clock assembly 100 may include other input/output (I/O) components 130. For example, the clock assembly 100 may include switches 132 (e.g., knobs, levers, dials, etc.). A switch 132(1) may adjust an amplitude of the signals generated by the drive inductor(s) 116, thereby adjusting a strength of the magnetic field to move the magnetic elements by greater or lesser amounts, a switch 132(2) may adjust a frequency of the signals generated by the drive inductor(s) 116, a switch 132(3) may adjust a strobe frequency of the lighting element(s) 120, and a switch 132(4) may adjust a brightness of the lighting element(s) 120. The lighting element(s) 120 may be controlled to different luminosities, frequencies, colors, patterns, etc.

The switch 132(1) and the switch 132(2) may be used to impart movement to the glassware 108, for example, via changing amplitude and frequency. Depending upon the type of glassware 108 (e.g., material, thickness, shape, etc.), the switch 132(1) and the switch 132(2) may be adjusted to impart movement to the glassware 108. The switch 132(3) and the switch 132(4) may adjust the lighting element(s) 120 to observe the movement of the glassware 108. In some instances, settings selected by a user interacting with the switches 132 may be stored as the data 128, and consequently, used to control functions of the clock assembly 100. In some instances, the output of the lighting element(s) 120 may be automatically adjusted based on characteristic(s) of the drive inductor(s) 116 and/or the sense inductor(s) 118.

Although shown as manual controls, in some instances, a user of the clock assembly 100 may control a function via touch-screens, etc. Moreover, the clock assembly 100 may communicatively couple to one or more devices (e.g., a mobile phone) via network interface(s) 134 (e.g., Bluetooth, Zigbee, etc.), whereby the user may utilize the one or more devices for controlling one or more functions of the clock assembly 100. The switches, although shown on the base 102, may also be located elsewhere on the clock assembly 100. Further, the clock assembly 100 may respond to data received from a phone, computer, etc. For example, in response to a text notification, e-mail, call, alarm, etc., the lighting element(s) 120 may change in color, or may strobe in such way as to make the glassware 108 appear to oscillate and/or pulse

Although not shown, the clock assembly 100 may include polarizers to allow internal stresses within the glassware 108 to be observed. Changing the color of light output by the lighting element(s) 120 may change the visualizations of the stresses observed through the polarizers. The polarizers may be held in place via various brackets, clamps, etc. In some instances, the polarizers may be secured to the posts 104, the struts 114, etc.

The clock assembly 100 may also include sensors, for example, that measure the temperature of the glassware 108. The sensed temperature may be used to alter the temperature of the glassware 108, for example, via heating (e.g., heatpad) or cooling the glassware 108 (e.g., fan). As the temperature of the glassware affects the frequency of oscillation of the glassware 108, the temperature may be controlled to adjust the frequency of oscillation. Additionally, or alternatively, the control signals provided to the drive inductor(s) 116 may be based at least in part on the temperature of the glassware 108, as measured, to adjust the frequency of oscillation. In some instances, the temperature measurement may serve to compensate for an actual temperature drift of the glassware 108 in the digital logic used to produce the timing and motor signals. Moreover, the temperature may be used to reduce the temperature drift of the glassware 108 from a reference point by actively controlling the temperature of the glassware 108. These two methods may be done in isolation or in tandem, and roughly correspond to TCXO (temperature-controlled crystal oscillators) and OCXO (oven-controlled crystal oscillators), which are common devices.

Components of the clock assembly 100 may be powered via a battery 136. In some instances, the battery 136 is disposed in the base 102 or the clock 106. Wires, connectors, etc., may route through the posts 104, the struts 114, etc., to the clock 106, the drive inductor(s) 116, the sense inductor(s) 118, the lighting element(s) 120, etc.

As used herein, a processor, such as the processor(s) 124 includes multiple processors and/or a processor having multiple cores. Further, the processor(s) 124 include one or more cores of different types. For example, the processor(s) 124 include application processor units, graphic processing units, and so forth. In one implementation, the processor(s) 124 comprise a microcontroller and/or a microprocessor. The processor(s) 124 include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that are used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 124 possess its own local memory, which also store program components, program data, and/or one or more operating systems.

Memory, such as the memory 126 includes volatile and nonvolatile memory, removable and non-removable media implemented in any method or technology for storage of information, such as computer-readable instructions, data structures, program component, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory is implemented as computer-readable storage media (“CRSM”), which could be any available physical media accessible by the processor(s) to execute instructions stored on the memory. In one basic implementation, CRSM could include random access memory (“RAM”) and Flash memory. In other implementations, CRSM could include but is not limited to, read-only memory (“ROM”), electrically erasable programmable read-only memory (“EEPROM”), or any other tangible medium that can be used to store the desired information and which can be accessed by the processor(s) 124. The memory 126 is an example of non-transitory computer-readable media. The memory 126 could store an operating system and one or more software applications, instructions, programs, and/or data to implement the methods described herein and the functions attributed to the various systems.

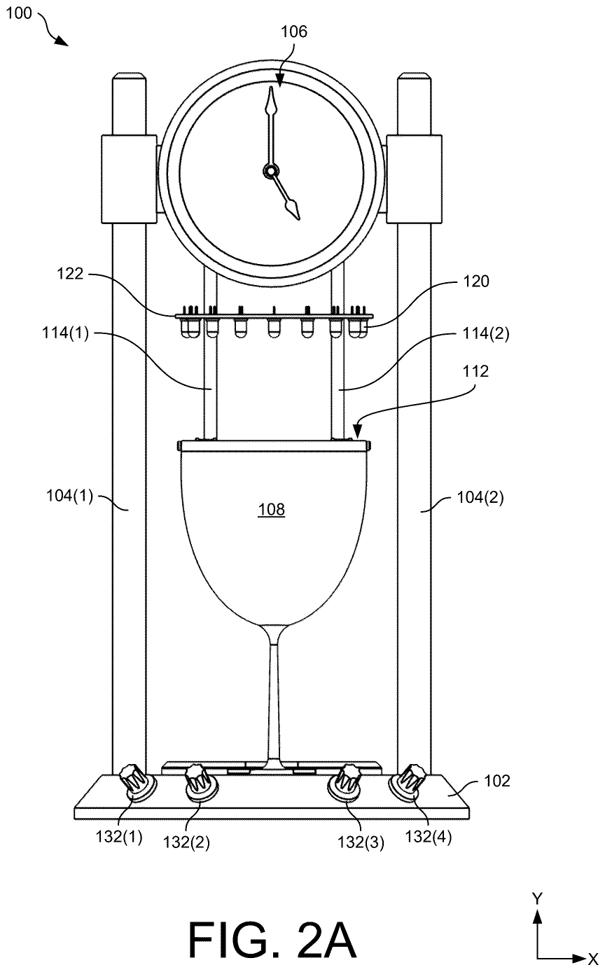

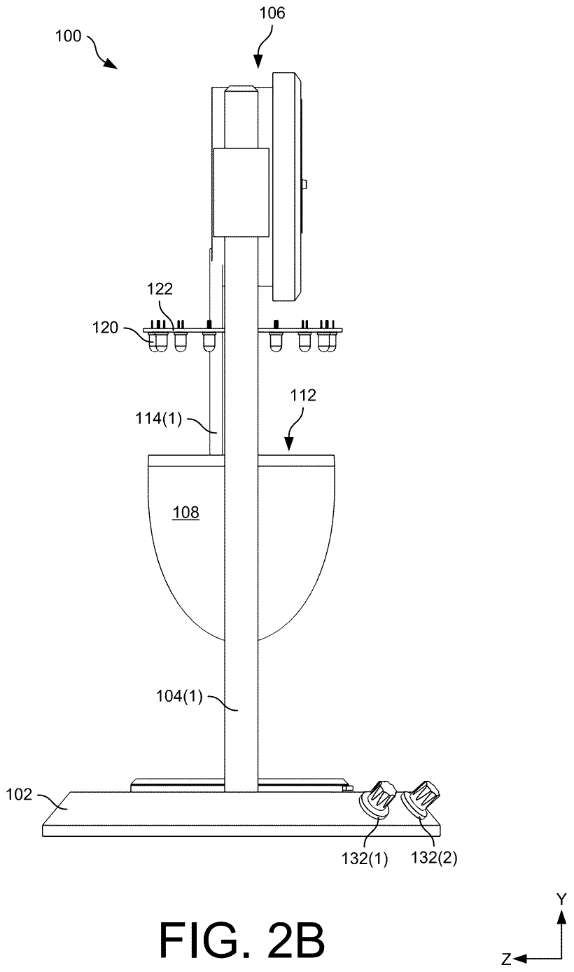

FIGS. 2A and 2B illustrate side views of the clock assembly 100, according to an example of the present disclosure. FIG. 2A may illustrate a front view of the clock assembly 100, while FIG. 2B may illustrate a side view of the clock assembly 100. As introduced above, the clock assembly 100 includes the base 102, the posts 104, the clock 106, the struts 114, and the lighting element(s) 120 disposed on the substrate 122. The frame 112 is disposed at least partially internal to the glassware 108. In some instances, and as shown, the lighting element(s) 120 are disposed vertically above the glassware 108 to emit light in a direction towards the glassware 108. In some instances, the lighting element(s) 120, via the substrate 122, may be adjustable along a length of the struts 114. In some instances, wires, cables, connectors, etc., that provide power and signals to/from the drive inductor(s) 116, the sense inductor(s) 118, the lighting element(s) 120, etc., may be disposed through the posts 104, the struts 114, etc.

The frame 112 may also be disposable at different locations along the struts 114 to lower the frame 112 into the glassware 108 (e.g., from the top). In some instances, the struts 114 may telescopically extend from the clock 106 (e.g., a housing of the clock 106) to raise and lower the frame 112 at least partially into the glassware 108. The base 102 includes the switches 132 for controlling a function of the clock assembly 100, such as the drive inductor(s) 116, the lighting element(s) 120, etc.

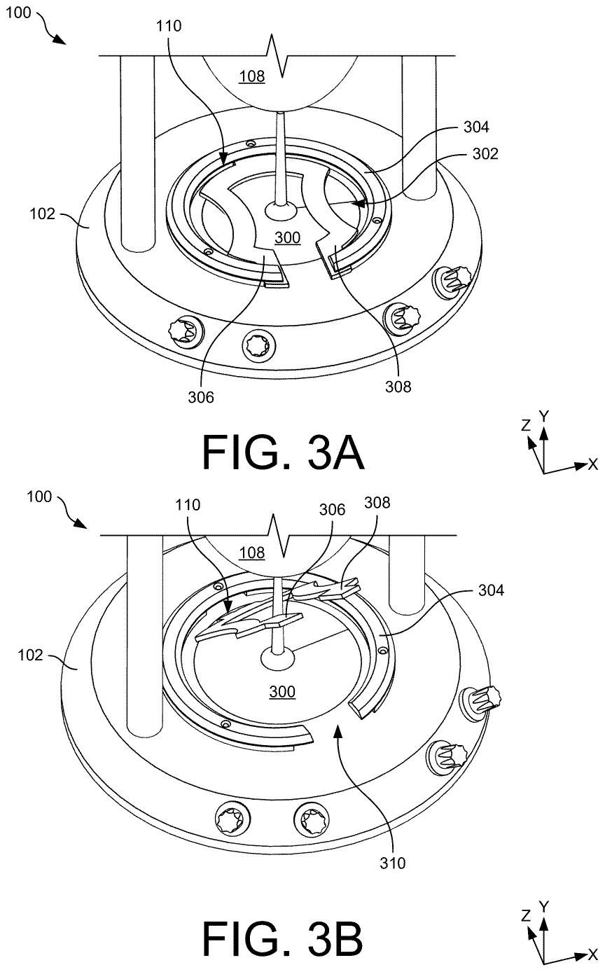

FIGS. 3A and 3B illustrate an operation of the attachment mechanism 110, according to an example of the present disclosure. In FIG. 3A, the attachment mechanism 110 is shown securing the glassware 108 to the base 102, while in FIG. 3B, the attachment mechanism 110 is shown being displaced to permit removal or insertion of the glassware 108.

The attachment mechanism 110 may hingedly couple to the base 102 to transition between a first state, position, etc., as shown in FIG. 3A and a second state, position, etc., as shown in FIG. 3B. In some instances, a bottom 300 of the glassware 108 is disposable within a receptacle 302 on the base 102, which may be formed via a ring 304. The attachment mechanism 110 may include a first arm 306 and a second arm 308 disposed over a top of the bottom 300. The first arm 306 and the second arm 308 may be biasable (e.g., in the X-direction) such that the first arm 306 and the second arm 308 are capable of being squeezed together. When squeezed together, the ends of the first arm 306 and the second arm 308 may be disposed through an opening 310 to transition the attachment mechanism 110 to the second state. Therein, the glassware 108 may be released from the receptacle 302. To secure the glassware 108 in the receptacle 302, the first arm 306 and the second arm 308 may be squeezed together and pushed through the opening 310. A natural bias of the first arm 306 and the second arm 308 prevents the first arm 306 and the second arm 308 from being lifted out of the opening 310 when in the first state.

Although the attachment mechanism 110 is shown including certain features, the attachment mechanism 110 may be different than shown. For example, the attachment mechanism 110 may be a twist-n-lock mechanism, may include straps or bands secured over the bottom 300 of the glassware 108, and so forth. Regardless of the specific embodiment, the attachment mechanism 110 may accommodate different sizes, types, etc., of the glassware 108.

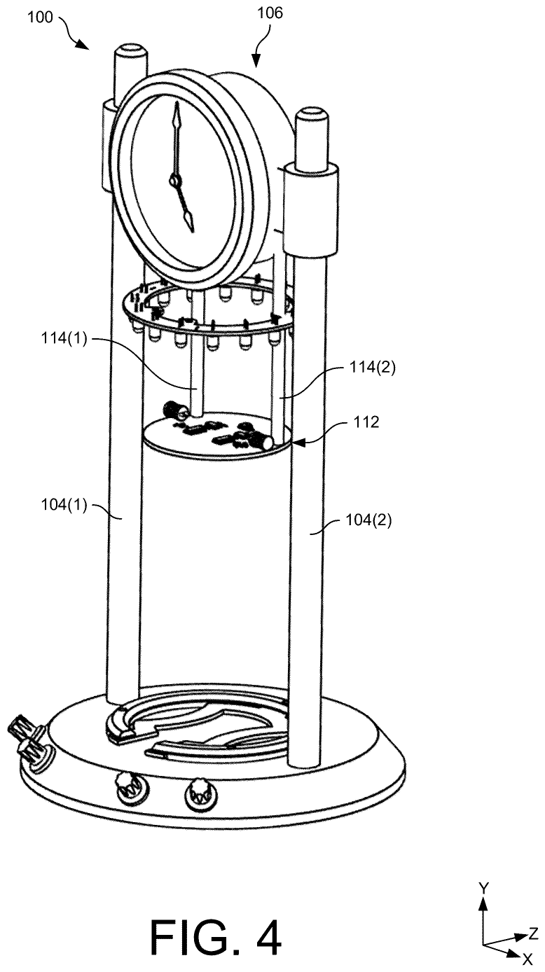

FIG. 4 illustrates an isometric view of the clock assembly 100, showing the glassware 108 removed, according to an example of the present disclosure. As shown, the frame 112 may be disposed on an end of the struts 114 to be disposed within the annulus of the glassware 108. In some instances, the frame 112, including the drive inductor(s) 116 and the sense inductor(s) 118, is sized to be at least partially disposed within the annulus of the glassware 108. In other instances, the frame 112 may be disposable external to the glassware 108 and/or adjacent to the glassware 108. In some instances, the frame 112 is adjustable in height along the struts 114 to accommodate different types of the glassware 108. For example, the struts 114 may be telescopically extending members that retract and extend from one another to raise and lower the frame 112.

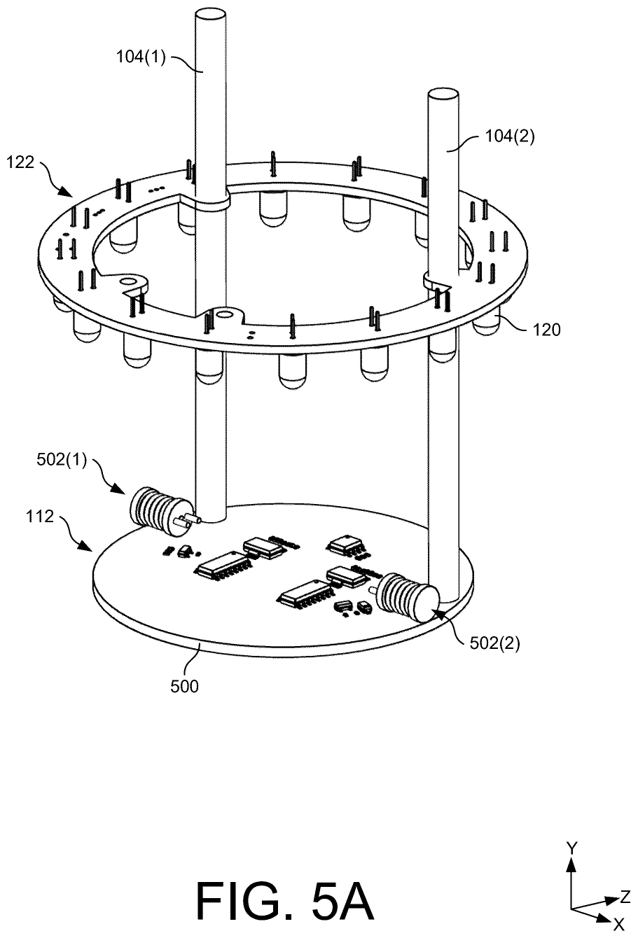

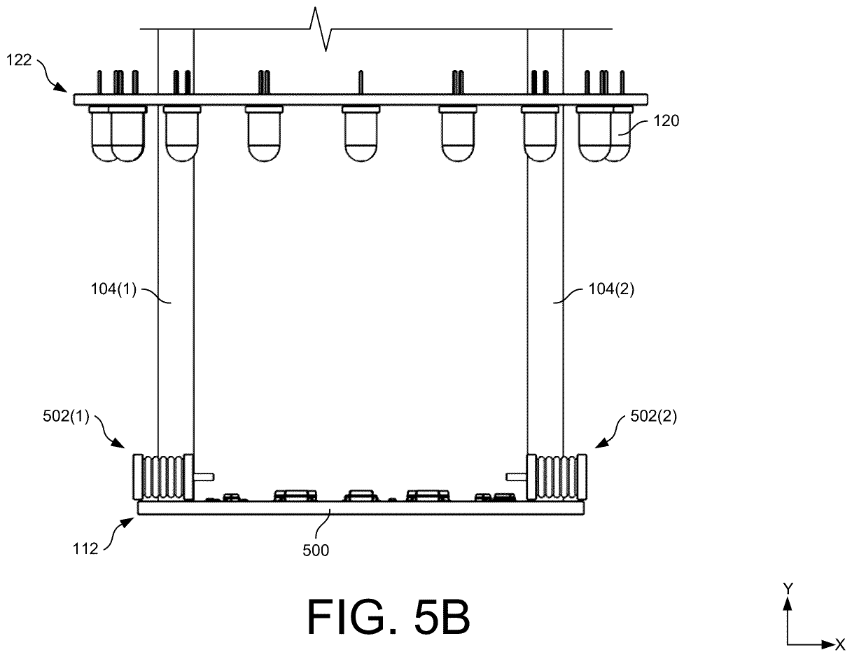

FIGS. 5A and 5B illustrate detailed views of the frame 112 and the substrate 122, according to an example of the present disclosure. The drive inductor(s) 116 and the sense inductor(s) 118 are disposed on the frame 112, which, in some instances, includes a PCB 500 to which the drive inductor(s) 116 and the sense inductor(s) 118 are mounted. In some instances, the drive inductor(s) 116 and the sense inductor(s) 118 are integrated within the drive and sense inductor(s) 502, in that the drive and sense inductor(s) 502 generate the signals to create the magnetic fields and generate the signals indicative of a magnetic field associated with the magnetic elements on the glassware 108. In this sense, the drive inductor(s) 116 and the sense inductor(s) 118 are combined.

As shown in FIGS. 5A and 5B, the clock assembly 100 may include two of the drive and sense inductor(s) 502, such as a drive and sense inductor(s) 502(1) and a drive and sense inductor(s) 502(2). The drive and sense inductor(s) 502 may be diametrically opposed from one another and may operate in unison to impart movement to the glassware 108. For example, while the drive and sense inductor 502(1) generates a signal that opposes a first set of magnetic elements on the glassware 108 (and move a portion of the glassware 108 leftward), the drive and sense inductor 502(2) generates a signal that attracts a second set of magnetic elements on the glassware 108 (and move a portion of the glassware 108 leftward). The drive and sense inductor(s) 502 may therefore push and pull on diametrically opposed portions of the glassware 108. For example, if the drive and sense inductor 502(1) generates a signal that displaces the first set of magnetic elements away from the drive and sense inductor 502(1), the drive and sense inductor 502(2) may generate a signal that displaces the second set of magnetic elements towards the drive and sense inductor 502(2).

In some instances, the data 128 generated by the drive and sense inductor(s) 502 is used to determine the vibrations of the glassware 108. For example, a feedback loop associated with the vibrations (or movement, deflection, etc.) of the glassware 108 may be used to generate signals for imparting the vibrations to the glassware 108.

Although shown as including two of the drive and sense inductor(s) 502, the clock assembly 100 may include any number of the drive and sense inductor(s) 502. In some instances, the clock assembly 100 may include an equal number of the drive and sense inductor(s) 502, or the clock assembly 100 may include an odd number of the drive and sense inductor(s) 502. In some instances, while the clock assembly 100 may include any number of the drive and sense inductor(s) 502 (e.g., six, ten, etc.), in some instances, only a portion of the drive and sense inductor(s) 502 may be used. For example, certain drive and sense inductor(s) 502 may be disabled or deactivated depending upon the desired movement of the glassware 108.

The lighting element(s) 120 are disposed on the substrate 122 and are arranged to output light in a direction towards the glassware 108. The substrate 122 may include any number of the lighting element(s) 120, and the lighting element(s) 120 may be controlled to adjust their strobe (e.g., on/off), their color, their brightness, a pattern, etc. Although shown as being separate from the frame 112, in some instances, the drive and sense inductor(s) 502 and the lighting element(s) 120 may be integrated within a single assembly.

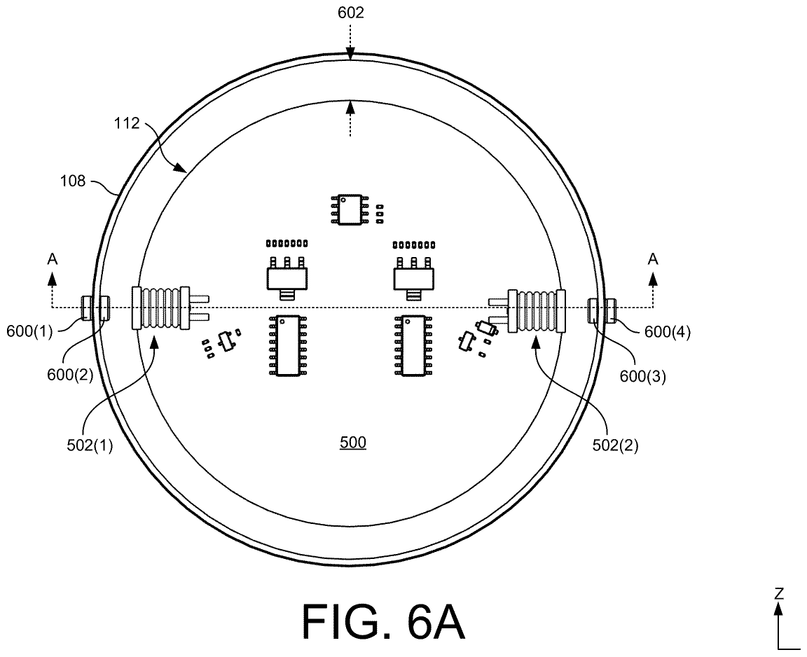

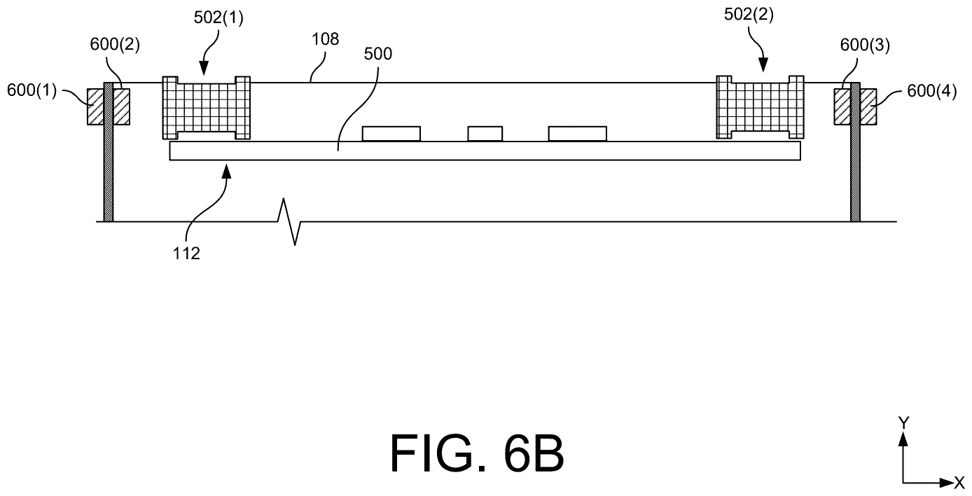

FIGS. 6A and 6B illustrate details of the drive and sense inductor(s) 502 disposed adjacent to magnetic elements on the glassware 108, according to an example of the present disclosure. FIG. 6B illustrates a cross-sectional view taken along line A-A of FIG. 6A. The magnetic element(s) 600 may include a magnetic element 600(1), a magnetic element 600(2), a magnetic element 600(3), and a magnetic element 600(4). The magnetic element 600(1) and the magnetic element 600(2) may be a first set of magnetic elements disposed adjacent to the drive and sense inductor 502(1). The magnetic element 600(3) and the magnetic element 600(4) may be a second set of magnetic elements disposed adjacent to the drive and sense inductor 502(2).

In some instances, the magnetic element(s) 600 may be integrated with the glassware 108, may be adhered to the glassware 108, etc. In some instances, the magnetic element 600(1) and the magnetic element 600(2) may be attracted to one another to secure to the glassware 108 (i.e., a thickness of the glassware 108 may be disposed between the magnetic element 600(1) and the magnetic element 600(2)). Likewise, the magnetic element 600(3) and the magnetic element 600(4) may be attracted to one another to secure to the glassware 108.

As introduced above, the drive and sense inductor 502(1) generates a magnetic field that either attracts or opposes the magnetic element 600(1) and/or the magnetic element 600(2). As the magnetic field is generated, the magnetic element 600(1) and/or the magnetic element 600(2) move away from or towards the drive and sense inductor 502(1). As the magnetic element 600(1) and/or the magnetic element 600(2) move, given the coupling to the glassware 108, a corresponding portion of the glassware 108 moves. The same is true for the interaction between the magnetic element 600(3) and/or the magnetic element 600(4) with the drive and sense inductor 502(2). In some instances, the drive and sense inductor 502(1) and the drive and sense inductor 502(2) operate in unison, such as the drive and sense inductor 502(1) generates a magnetic field that pushes the glassware 108 away, the drive and sense inductor 502(2) generates a magnetic field that pulls the glassware 108 inward. This may form a push-and-pull relationship between diametrically opposed locations on the glassware 108.

Still, as discussed above, the clock assembly 100 may include more than the drive and sense inductor 502(1) and the drive and sense inductor 502(2). For example, the clock assembly 100 may include four, six, twelve, etc., of the drive and sense inductor(s) 502. In such instances, the drive and sense inductor 502 may operate as a group, or collectively, to push and pull corresponding portions of the glassware 108. Sensing a movement of the glassware 108 may be used to control the magnetic fields and/or sustain movement in the glassware 108.

An edge of the frame 112 and an interior surface of the glassware 108 may be separated by a gap distance 602. The gap distance 602 permits displacement of the glassware 108 without contacting the frame 112. The frame 112 or the PCB 500 may include other computing components (e.g., resistors, capacitors, etc.) that permit operation and function of the drive and sense inductor(s) 502.

Although described as including the magnetic element(s) 600, in some instances, a portion of the glassware 108 may be selectively electroplated with a thin layer of metal. A corresponding electrode may be used in place of an inductor to drive the glassware 108 capacitively. Moreover, in some instances, the magnetic element(s) 600 are located at antinodes of the glassware 108.

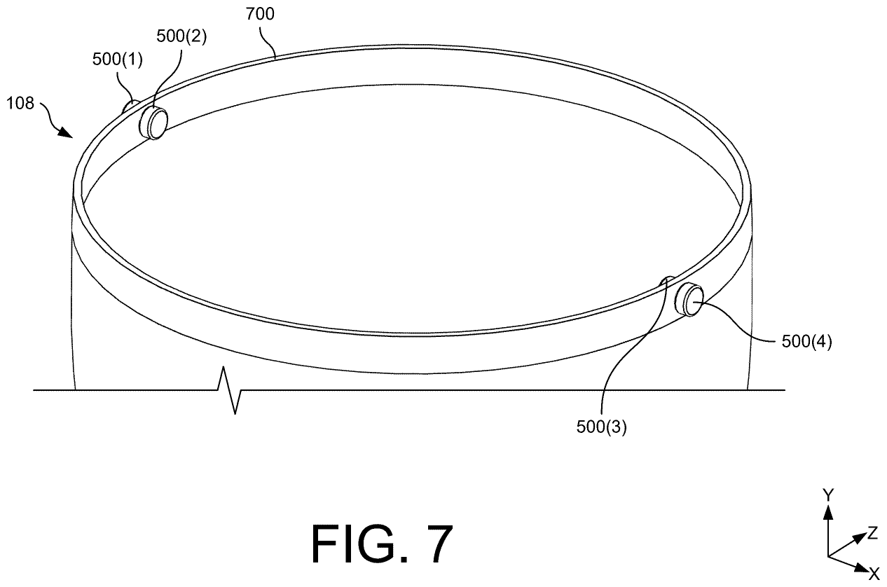

FIG. 7 illustrates a partial view of the glassware 108, according to an example of the present disclosure. The glassware 108 includes an annulus 700 through which the frame 112 is at least partially disposable. In doing so, the drive and sense inductor(s) 502 may be disposed at least partially internal to the annulus. As shown, the magnetic element 600(1) and the magnetic element 600(2) may be disposed at a first location on the glassware 108, and the magnetic element 600(3) and the magnetic element 600(4) may be disposed at a second location on the glassware 108, opposite the first location.

In some instances, two of the magnetic elements may be used to secure the glassware 108. For example, the magnetic element 600(1) and the magnetic element 600(2) may attract one another to secure the glassware 108. However, in some instances, only one of the magnetic element 600(1) or the magnetic element 600(2) may be used, and in such instances, the single magnetic element may be coupled, adhered, affixed, etc., to the glassware 108. In other words, another of the magnetic elements may not be needed to secure the single magnetic element to the glassware 108.

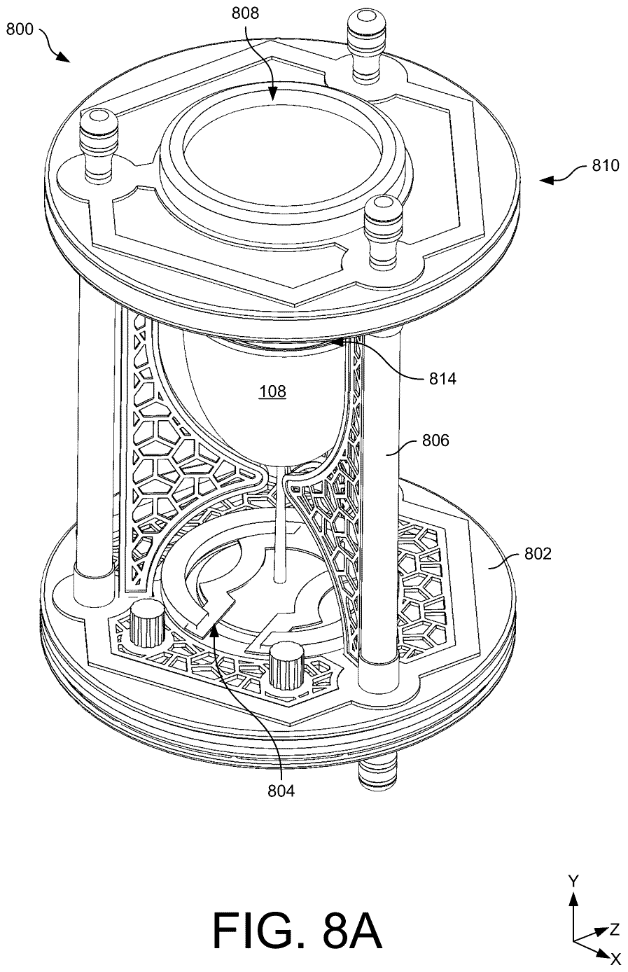

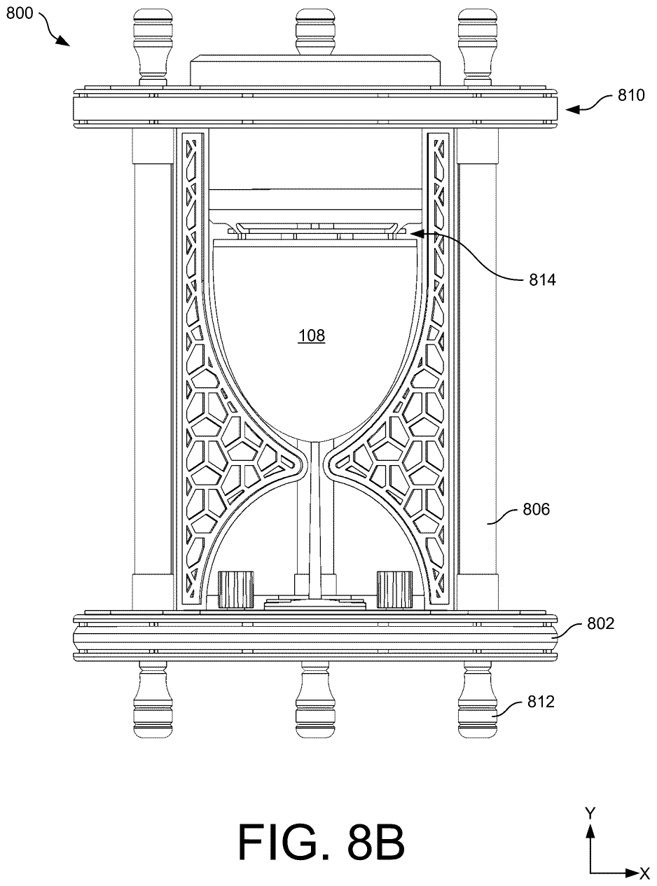

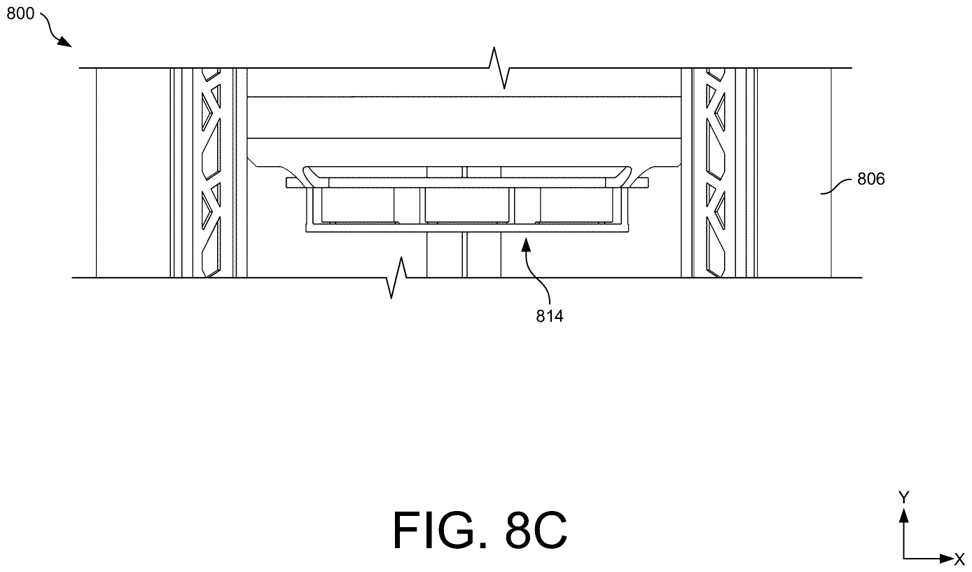

FIGS. 8A-8C illustrate an example clock assembly 800, according to an example of the present disclosure. In some instances, the clock assembly 800 may be similar to the clock assembly 100 as discussed above. For example, the clock assembly 800 may include a base 802 having an attachment mechanism 804 that secures to a bottom of the glassware 108, posts 806 that extend from the base 802, and a clock 808. The clock 808 may be disposed on a top 810, and pegs 812 may extend from the base 802 to support the base 802 above a surface. In some instances, the clock 808 may correspond to a display.

In FIG. 8C, which shows the glassware 108 removed, the clock assembly 800 includes a frame 814. The frame 814 includes lighting elements, inductors (e.g., drive and sense inductors), and other computing components that permit an operation of the clock assembly 800. The frame 814 extends from the top 810 and is disposable at least partially within the annulus 700 of the glassware. In some instances, the glassware 108 is removable via uncoupling the top 810 from the posts 806 to dispose the frame 814 external to the glassware 108.

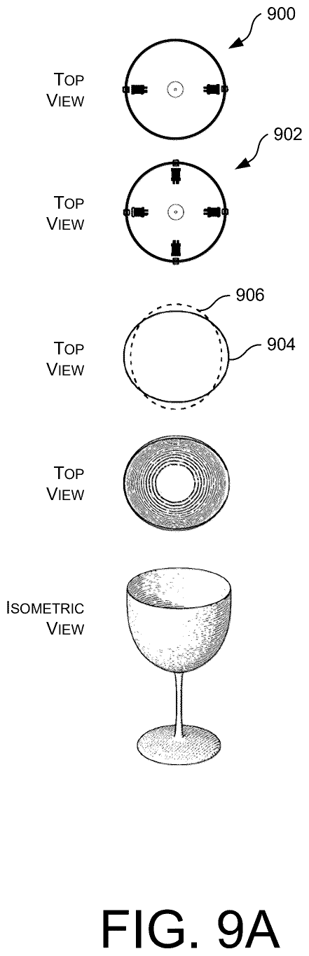

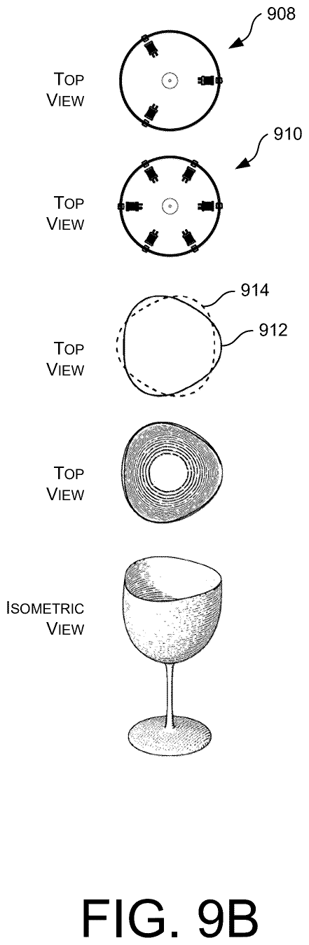

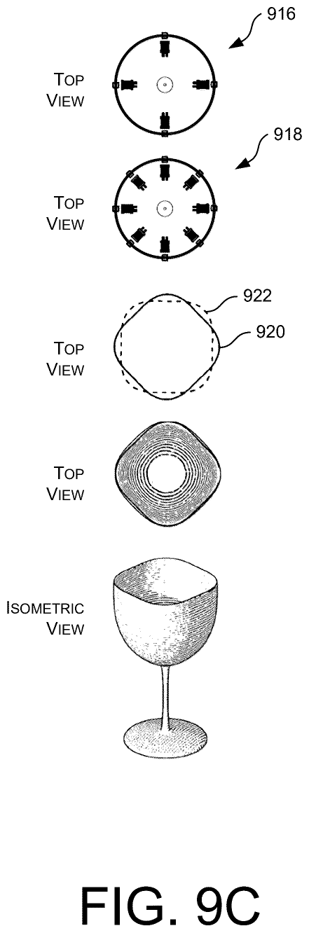

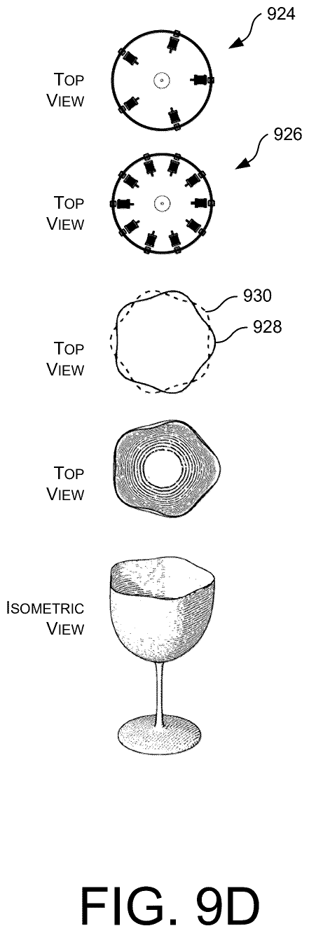

FIGS. 9A-9D illustrates various arrangements of the drive and sense inductors 502, according to an example of the present disclosure. In FIG. 9A, a first arrangement 900 includes two of the drive and sense inductors 502, spaced apart 180 degrees from one another. In the first arrangement 900, which is discussed in detail herein, the drive and sense inductors 502 may operate in unison to push and pull portions of the glassware 108. Also in FIG. 9A, a second arrangement 902 includes four of the drive and sense inductors 502, spaced apart 90 degrees from one another. In the second arrangement 902, two pairs of the drive and sense inductors 502 are included, where each pair may be diametrically opposed from one another and operate in unison to push and pull portions of the glassware 108. When the first pair is driven, the glassware 108 may have a first shape 904, and when the second pair is driven, the glassware 108 may have a second shape 906. The first shape 904 and the second shape 906 may be ovular. In other words, the first arrangement 900 and the second arrangement 902 may deflect the glassware 108 in an ovular shape.

In some instances, not all of the drive and sense inductors 502 may be activated. For example, in the second arrangement 902, if the first shape 904 is desired, one of the pairs of the drive and sense inductors 502 may be deactivated. If the first shape 904 and the second shape 906 are desired, the second arrangement 902 may be implemented, whereby the drive and sense inductors 502 are permitted to form the oval shape of the glassware 108 in different directions

In FIG. 9B, a third arrangement 908 includes three of the drive and sense inductors 502, spaced apart 120 degrees from one another. In the third arrangement 908, an odd number of the drive and sense inductors 502 is shown. In some instances, the drive and sense inductors 502 in the third arrangement 908 may operate in unison to push and pull portions of the glassware 108. Also in FIG. 9B, a fourth arrangement 910 includes four of the drive and sense inductors 502, spaced apart 60 degrees from one another. In the fourth arrangement 910, three pairs of the drive and sense inductors 502 are included, where each pair may be diametrically opposed from one another and operate in unison to push and pull portions of the glassware 108. As shown, when the third arrangement 908 is driven, the glassware 108 may have a third shape 912, and when the fourth arrangement 910 is driven, the glassware 108 may have a fourth shape 914. The third shape 912 and the fourth shape 914 may be triangular. Both the third arrangement 908 and the fourth arrangement 910 may be used to form a triangular shape of the glassware 108, however, the fourth arrangement 910 is capable of forming the triangular shape in different directions.

In FIG. 9C, a fifth arrangement 916 includes four of the drive and sense inductors 502, spaced apart 90 degrees from one another. In the fifth arrangement 916, the drive and sense inductors 502 may operate in unison to push and pull portions of the glassware 108. Also in FIG. 9C, a sixth arrangement 918 includes eight of the drive and sense inductors 502, spaced apart 45 degrees from one another. In the sixth arrangement 918, four pairs of the drive and sense inductors 502 are included, where each pair may be diametrically opposed from one another and operate in unison to push and pull portions of the glassware 108. As shown, when the fifth arrangement 916 is driven, the glassware 108 may have a fifth shape 920, and when the sixth arrangement 918 is driven, the glassware 108 may have a sixth shape 922. The fifth shape 920 and the sixth shape 922 may be square. Both the fifth arrangement 916 and the sixth arrangement 918 may be used to form a square shape of the glassware 108, however, the sixth arrangement 918 is capable of forming the square shape in different directions.

The second arrangement 902 and the fifth arrangement 916 both include four of the drive and sense inductors 502. However, the second arrangement 902 forms the oval shape while the fifth arrangement 916 forms the square shape. In some instances, this is based on whether the pairs of the drive and sense inductors 502 are pushing or pulling the glassware 108, or stated alternatively, the corresponding displacement of the glassware 108. For example, in the second arrangement 902, the pairs of the drive and sense inductors 502 may operate in tandem in that one of the pairs may push the glassware 108 outwards, while another of the pairs pulls the glassware 108 inward. This forms the oval shape. Comparatively, in the fifth arrangement 916, all of the drive and sense inductors 502 may pull and push on portions of the glassware 108 simultaneously. In other words, the drive and sense inductors 502 may pull on the glassware 108 in unison and may push on the glassware 108 in unison.

In FIG. 9D, a seventh arrangement 924 includes five of the drive and sense inductors 502, spaced apart 72 degrees from one another. In the seventh arrangement 924, an odd number of the drive and sense inductors 502 is shown. Also in FIG. 9D, an eighth arrangement 926 includes ten of the drive and sense inductors 502, spaced apart 36 degrees from one another. In some instances, the drive and sense inductors 502 in the eighth arrangement 926 may operate in unison to push and pull portions of the glassware 108. As shown, when the seventh arrangement 924 is driven, the glassware 108 may have a seventh shape 928, and when the eighth arrangement 926 is driven, the glassware 108 may have an eighth shape 930. The seventh shape 928 and the eighth shape 930 may be a pentagon. Both the seventh arrangement 924 and the eighth arrangement 926 may be used to form a pentagon shape of the glassware 108, however, the eighth arrangement 926 is capable of forming the pentagon shape in different directions.

The arrangements as shown in FIGS. 9A-9D are exemplary, and the drive and sense inductors 502 may be arranged differently than shown. Moreover, as contemplated herein, different pairs of the drive and sense inductors 502 may be driven to achieve a desired shape, or individual ones of the drive and sense inductors 502 may be driven to achieve a desired shape. Still, the frequency, amplitude, etc., of the signals generated by the drive and sense inductors 502 may be altered to achieve the desired shape, an amount of displacement, etc. In some instances, the magnetic elements and/or the drive and sense inductors may be located at antinodes of the glassware 108 and/or adjacent to the antinodes, respectively.

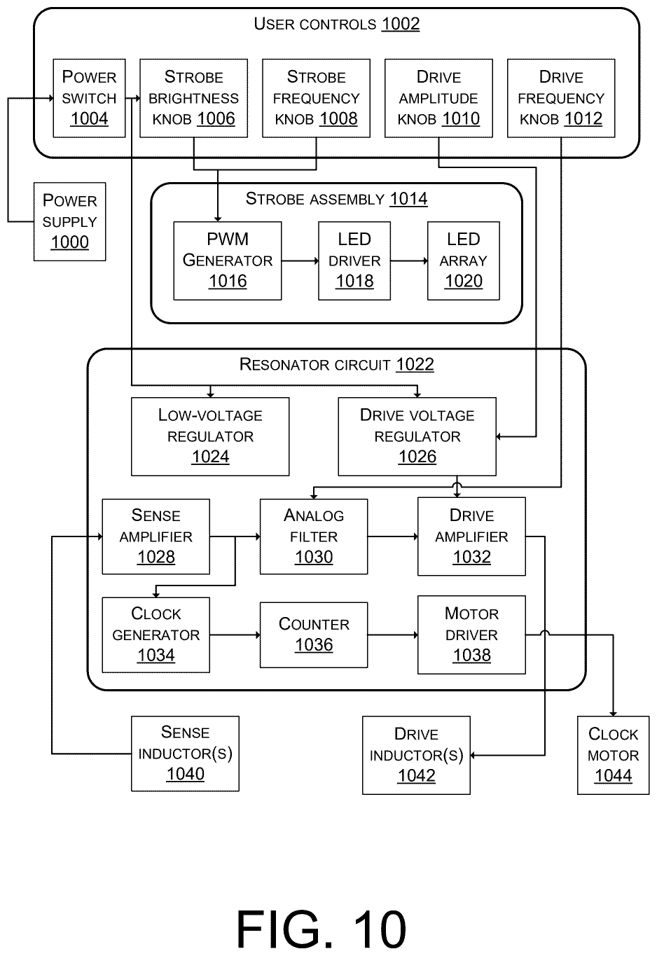

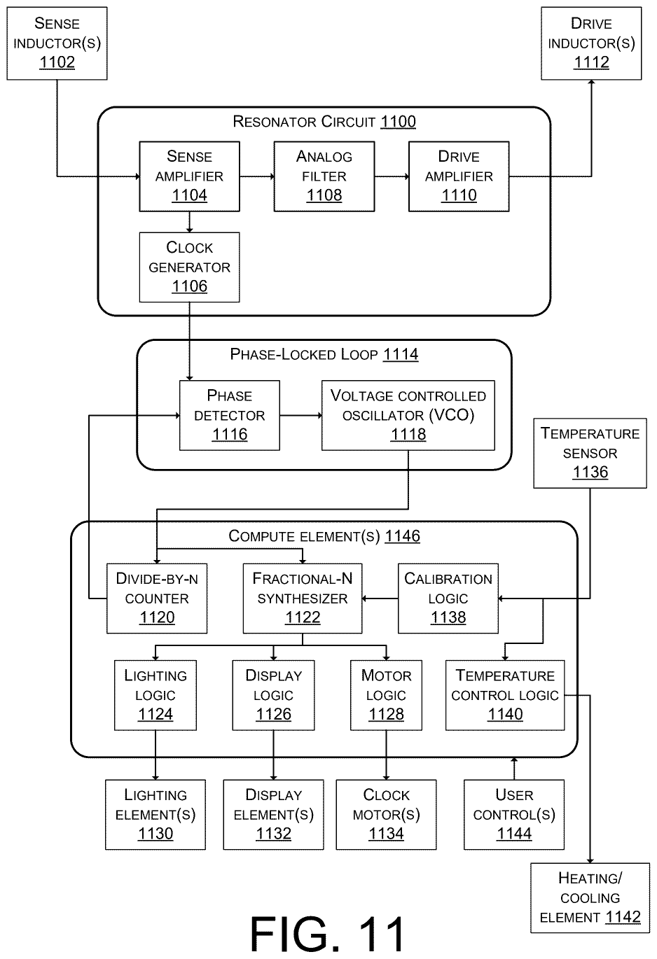

FIG. 10 illustrates a functional block diagram of the clock assembly 100, according to an example of the present disclosure. A power supply 1000 provides power to components of the clock assembly 100. In some instances, the power supply 1000 may be mains-powered, battery-powered (e.g., the battery 136), solar-powered, etc. User controls 1002, such as the switches 132, may include a power switch 1004 and adjustment switches (e.g., knobs) for strobe brightness 1006, strobe frequency 1008, drive amplitude 1010, and drive frequency 1012. A strobe assembly 1014 (e.g., the lighting element(s) 120) may include a pulse width modulation (PWM) generator 1016, a LED driver 1018, and a LED array 1020. In some instances, a FPGA or a phase-locked loop control may be used to control and generate signals rather than the PWM generator 1016.

The clock assembly 100 may include a resonator circuit 1022 with a low-voltage regulator 1024, a drive voltage regulator 1026, a sense amplifier 1028, an analog filter 1030, a drive amplifier 1032, a clock generator 1034, a counter 1036, and a motor driver 1038. A sense inductor 1040 provides signals to the sense amplifier 1028 to detect a vibration of the glassware 108. The drive amplifier 1032 provides signals to a drive inductor 1042 to sustain the vibration to the glassware 108 through the application of a magnetic field. The drive inductors 1042 create the magnetic field and the magnetic field may interact with magnetic element(s) 600 (e.g., permanent magnetic, ferrous material, electromagnet, etc.) coupled to the glassware 108.

Adjusting the user controls 1002 may adjust the current applied to the drive inductor 1042, thereby affecting the magnetic field. The strength of the magnetic field may adjust the oscillations perceived by the glassware 108. For example, adjusting the amplitude may adjust a physical motion of the glassware 108. A clock motor 1044 drives the hands of the clock 106 based on the processed signals.

In some instances, the clock 106 operates by developing a standing wave on the glassware 108 with a high Q resonant mode. The motion of the glassware 108 causes the magnetic element(s) 600 to move relative to the sense inductor(s) 118, thereby inducing a current. This current is amplified and filtered by before being sent to the drive inductor(s) 116, whereby a magnetic field is created to push or pull on the magnetic element(s) 600, thereby sustaining a vibration of the glassware 108.

The clock signal is generated from the sense signal by means of digital logic and is used to drive a Lavet-type stepping motor to move the hands of the clock 106. If the glassware 108 is tuned to a frequency that is a power of 2, the motor drive signal may be generated directly from an output of the counter 1036. For example, if the glassware 108 is tuned to 256 Hz, then the 9th bit of the counter 434 will change state every second and may be used to generate a motor drive output. For glassware with natural frequencies that are not powers of 2, an additional binary comparator may be used to identify when the correct number of cycles has elapsed.

The strobe assembly 1014, realized using a ring of high-brightness LEDs, is overdriven at a high voltage and flashed at a low duty cycle (5-10%) to avoid motion blur of the glassware 108. The strobe frequency may be set at or near the vibration frequency of the glassware 108, making the motion of the glassware 108 (or the rim/annulus 700) easily visible to the naked eye. Users may adjust the strobe frequency to change the beat frequency between the strobe and the vibration of the glassware 108, thus altering the perceived speed and pattern of the motion of the glassware 108. Different strobe colors may be pulsed at different frequencies and phase offsets to achieve various visual effects. In some instances, the strobe frequency may be coordinated or synchronized with the resonator circuit 1022.

The clock 106 may be tuned to excite and utilize different vibration modes of the glassware 108. Lower frequency modes typically result in larger amplitude vibrations, which are more visually impressive when illuminated by the strobe assembly 1014. Higher frequency modes, while less visually dramatic, may provide more accurate timekeeping. The selection of the excited vibration frequency is achieved through adjustment of the User controls 1002 that modify parameters in the filter network.

In some instances, a frequency of oscillation may be adjusted by affixing weights to the glassware 108. For example, by placing weights on a rim of the glassware 108 at vibration nodes and moving them towards the antinodes, the frequency of vibration may be continuously lowered. Small weights may be used for fine adjustment and larger weights for larger adjustments. Additionally, or alternatively, weights may be placed towards the bottom of the glassware and moved upward toward the rim to adjust the frequency downward.

FIG. 11 illustrates a functional block diagram of the clock assembly 100, according to an example of the present disclosure. The functional block diagram may include a resonator circuit 1100 having a sense amplifier communicatively connected to sense inductor(s) 1102. The sense amplifier 1104 is also communicatively connected to a clock generator 1106 and an analog filter 1108. A drive amplifier 1110 communicates with drive inductor(s) 1112.

In some instances, a phase-locked loop (PLL) 1114 may be used to generate a second clock signal from the output of the clock generator 1106. In this way a higher-frequency clock may be generated suitable for driving one or more compute elements 1146 (e.g., digital logic circuits, microcontrollers, field-programmable gate arrays, etc.) that are synchronized to the phase of the oscillation of the glassware 108. The output of the clock generator 1106 may be passed into the PLL 1114 as a first clock signal. The PLL 1114 may include a phase detector 1116 for comparing the first and second clock signals to be synchronized, and a voltage controlled oscillator (VCO) 1118 for generating a second clock signal. Additionally, or alternatively, the second clock signal may be passed through a divide-by-N counter 1120 before being passed into the phase detector 1116 to achieve an N-times multiplication of the first frequency.

In some instances, this second clock signal may be used to drive a compute element comprising a field-programmable gate array (FPGA). The FPGA may be used to subsume various functions of the previously-described resonator circuit 1022 and strobe assembly 1014, and/or to affect additional logic functions. For example, the FPGA may be programmed or configured to generate clock signals, motor output signals, lighting signals, and/or display signals. Additionally or alternatively, the FPGA may be configured to include a divide-by-N counter, with its input driven by the output of the VCO 1118 and its output directed back to the PLL 1114 as the second clock signal. In this way, the divisor of the divide-by-N counter 1120 (and, equivalently, the frequency multiplication achieved by the PLL), may be controlled or tailored to a specific glassware by reprogramming or reconfiguring the FPGA.

Additionally, or alternatively, the FPGA may be configured to include logic to generate a precise, calibrated clock output signal for driving various functions. For example, some instances may employ a fractional-N synthesizer 1122, configured to convert the output of the VCO 1118 to a precise desired output frequency (e.g., 100 Hz). This calibrated clock output signal may be used to drive lighting logic 1124, display logic 1126, and/or motor logic 1128. Lighting logic 1124 may be used to drive one or more lighting element(s) 1130 (LEDs, laser diodes, etc.). Display logic 1126 may be used to configure and drive one or more external user display element(s) 1132 (LCD, OLED, etc.). Motor logic 1128 may be used to drive one or more clock motor(s) 1134.

Additionally, or alternatively, the FPGA may receive temperature measurements from a temperature sensor 1136. These temperature measurements may be passed into calibration logic 1138, which may adjust parameters of the fractional-N synthesizer 1122 to compensate for changes in the glassware's oscillation frequency. Additionally, or alternatively, the temperature measurements may be directed to temperature control logic 1140, which may be employed to control the temperature of the glassware through a heating/cooling element 1142 (e.g., a resistive heating element, Peltier cell, light, etc.). Additional sensors may be employed in this manner to compensate for various changes in the glassware oscillation frequency (e.g., due to humidity, air pressure, acceleration, vibration, rotation, etc.).

Additionally, user controls 1144 such as buttons, knobs, potentiometers, etc., may be connected to the FPGA and their outputs used to adjust various parameters of the FPGA logic elements.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A clock assembly comprising:
a base configured to receive a bottom of a glassware;
one or more posts extending from the base;
a clock disposed on the one or more posts;
a frame configured to be at least partially disposed within an annulus of the glassware, the frame including:
a first drive and sensing inductor configured to:
generate a first magnetic field to displace one or more first magnetic elements disposed on the glassware, and
sense a first movement associated with the one or more first magnetic elements, and
a second drive and sensing inductor configured to:
generate a second magnetic field to displace one or more second magnetic elements disposed on the glassware, and
sense a second movement associated with the one or more second magnetic elements; and
one or more lighting elements configured to output light to illuminate the glassware.

2. The clock assembly of claim 1, wherein the one or more lighting elements are disposed between the clock and the frame.

3. The clock assembly of claim 1, wherein the light output by the one or more lighting elements is based at least in part on at least one of the first movement or the second movement.

4. The clock assembly of claim 1, further comprising one or switches to adjust at least one of:
the first magnetic field;
the second magnetic field; or
the light output by the one or more lighting elements.

5. The clock assembly of claim 1, wherein:
the one or more first magnetic elements are disposed at a first antinode of the glassware; and
the one or more second magnetic elements are disposed at a second antinode of the glassware.

6. A clock assembly comprising:
a base on which a glassware is disposable;
a driving mechanism to impart a vibration to the glassware;
a sensing mechanism to detect the vibration of the glassware;
a resonator circuit to (i) generate a first signal for the driving mechanism to impart the vibration to the glassware and (ii) process a second signal from the sensing mechanism to detect the vibration of the glassware;
a clock circuit to generate a third signal based at least in part on the second signal;
a clock to output a time based at least in part on the third signal; and
a light source to illuminate the glassware.

7. The clock assembly of claim 6, wherein:
the driving mechanism includes at least one of an drive inductor, a capacitive driver, or an acoustic driver; and
the sensing mechanism includes at least of a sense inductor, a capacitive sensor, an optical sensor, or an acoustic sensor.

8. The clock assembly of claim 6, wherein one or more magnetic elements are coupled to the glassware proximate to the driving mechanism.

9. The clock assembly of claim 6, wherein the light source illuminates the glassware based at least in part on at least one of the first signal or the second signal.

10. The clock assembly of claim 6, wherein at least one of the driving mechanism or the sensing mechanism is disposed at least partially within an annulus of the glassware.

11. The clock assembly of claim 6, further comprising:
a second driving mechanism to impart a second vibration to the glassware; and
a second sensing mechanism to detect the second vibration of the glassware.

12. The clock assembly of claim 11, wherein the resonator circuit (i) generates a third signal for the second driving mechanism to impart the second vibration to the glassware and (ii) processes a fourth signal from the second sensing mechanism to detect the second vibration of the glassware.

13. The clock assembly of claim 12, wherein the driving mechanism and the second driving mechanism are diametrically opposed from one another.

14. An assembly comprising:
a base;
a frame disposable at least partially within a glassware;
a first drive and sense inductor disposed on the frame;
a second drive and sense inductor disposed on the frame;
lighting elements;
one or more processors; and
one or more non-transitory computer-readable media storing computer-executable instructions that, when executed by the one or more processors, cause the one or more processors to perform acts comprising:
send a first signal associated with the first drive and sense inductor generating a first magnetic field,
send a second signal associated with the second drive and sense inductor generating a second magnetic field,
receive a third signal associated with a first movement of a first magnetic element disposed adjacent to the first drive and sense inductor,
receiving a fourth signal associated with a second movement of a second magnetic element disposed adjacent to the second drive and sense inductor, and
cause the lighting elements to output light.

15. The assembly of claim 14, the acts further comprising:
receiving data associated with an adjustment to a movement of the glassware;
send a third signal associated with the first drive and sense inductor generating a third magnetic field, the third magnetic field being different than the first magnetic field; and
send a fourth signal associated with the second drive and sense inductor generating a fourth magnetic field, the fourth magnetic field being different than the second magnetic field.

16. The assembly of claim 14, wherein the first movement is opposite the second movement.

17. The assembly of claim 14, wherein:
the assembly further comprises:
a third drive and sense inductor disposed on the frame; and
a fourth drive and sense inductor disposed on the frame; and
the acts further comprise:
send a third signal associated with the third drive and sense inductor generating a third magnetic field,
send a fourth signal associated with the fourth drive and sense inductor generating a fourth magnetic field,
receive a sixth signal associated with a third movement of a third magnetic element disposed adjacent to the third drive and sense inductor, and
receive a seventh signal associated with a fourth movement of a fourth magnetic element disposed adjacent to the fourth drive and sense inductor.

18. The assembly of claim 14, further comprising one or more switches to adjust at least one of:
the first magnetic field;
the second magnetic field; or
the light.

19. The assembly of claim 14, further comprising a clock, the acts further comprising generating, based at least in part on at least of the third signal or the fourth signal, a fifth signal indicating a time to be output by the clock.

20. The assembly of claim 14, wherein the light output by the lighting elements is based at least in part on at least one of the third signal or the fourth signal.
